(19) United States
(12) Patent Application Publication
(10) Pub. No.: US 2022/0180186 A1
(43) Pub. Date: Jun. 9, 2022

(54) MACHINE LEARNING TECHNIQUES FOR GENERATING ENJOYMENT SIGNALS FOR WEIGHTING TRAINING DATA

(71) Applicant: NETFLIX, INC., Los Gatos, CA (US)

(72) Inventors: Justin Derrick BASILICO, Los Gatos, CA (US); Jiangwei PAN, Los Gatos, CA (US)

(21) Appl. No.: 17/192,515

(22) Filed: Mar. 4, 2021

Related U.S. Application Data
(60) Provisional application No. 63/121,768, filed on Dec. 4, 2020.

(51) Int. Cl. G06N 3/08

(52) U.S. Cl. CPC G06N 3/08

(57) ABSTRACT

Various embodiments set forth systems and techniques for training a personalized prediction model. The techniques include generating, based on interaction data associated with one or more users and a first weight associated with the interaction data, a first set of training data; generating, based on the personalized prediction model, a predicted enjoyment signal associated with playback of a digital content item; generating, based on the first set of training data and the predicted enjoyment signal, a second set of training data; and updating one or more parameters of a personalized ranking model based on the second set of training data.

### CROSS-REFERENCE TO RELATED APPLICATIONS

This application claims priority benefit of the United States Provisional Patent Application titled, “MACHINE LEARNING TECHNIQUES FOR GENERATING ENJOYMENT SIGNALS FOR WEIGHTING TRAINING DATA,” filed on Dec. 4, 2020 and having Ser. No. 63/121,768. The subject matter of the related application is hereby incorporated herein by reference.

### BACKGROUND

### Field of the Various Embodiments

The various embodiments relate generally to computer science, and more specifically, to machine learning techniques for generating enjoyment signals for weighting training data.

### DESCRIPTION OF THE RELATED ART

The recent proliferation of digital content (e.g., movies, games, music, podcasts, news, sports, audio, video, ringtones, advertisements, broadcasts, or the like) has increased the need to personalize content to suit the individual tastes and preferences of the users. Many applications allow users to interactively select, playback, and provide feedback (e.g., review, thumbs up, rating, or the like) on the digital content. For instance, when digital content is played back, the digital content may receive positive interaction after playback, such as a positive review or a thumbs up.

Many digital content applications use ranking algorithms that rely on user feedback data to rank digital content. For instance, a digital content item that has received a lot of positive feedback (e.g., thumbs up) is likely to be ranked higher relative to other digital content items that have not been ranked or that have received negative feedback (e.g., thumbs down). The outputs of the ranking algorithms can be used to determine which digital content items in a media library to present to a user interface of an endpoint device.

However, the ranking algorithms are often ineffective for digital content items where the users have not provided feedback. This problem is exacerbated by the fact that the vast majority of users consume digital content items but do not provide feedback after watching the content items. As a result, the user feedback data is not representative of all types of users, and, instead, reflects the preferences of the minority of users who tend to provide most of the feedback on digital content items. Since most ranking algorithms are trained based on this user feedback data, the ranking algorithms tend to provide rankings that are skewed towards reflecting the preferences of users who are overrepresented in the user feedback data.

In addition, the number of digital content items in a media library that receive feedback after playback is much smaller than the number of digital content items in the media library that do not receive any such feedback. As a result, ranking algorithms are more likely to be trained on types of digital content items that tend to receive user feedback, which may not be representative of all types of digital content items. As a result, the ranking algorithms are more likely to rank digital content items of a type similar to those that received feedback higher than other digital content items, resulting in homogenized recommendations that reflect certain types of digital content items and, as a result, reduce user engagement.

Further, some ranking algorithms rely on a viewing history of a user to provide a personalized ranking of digital content items. However, the tendency of most users to view items without providing feedback makes it difficult for such ranking algorithms to create personalized predictions suited to the preferences of the user, especially for users who tend to view a broad range of digital content items that may be different from the types of digital content that the ranking algorithms encountered during training. Additionally, ranking algorithms typically do not have any means for determining changes or variations in user preferences over time, which makes it more difficult to generate personalized predictions that increase user engagement.

Accordingly, there is a need for improved techniques for gauging whether users enjoyed watching digital content items where no explicit feedback is provided. There is also a need for improved techniques for generating training data that is representative of all types of users and digital content items.

### SUMMARY

One embodiment of the present invention sets forth a computer-implemented method for training a personalized prediction model, the method comprising generating, based on interaction data associated with one or more users and a first weight associated with the interaction data, a first set of training data; generating, based on the personalized prediction model, a predicted enjoyment signal associated with playback of a digital content item; generating, based on the first set of training data and the predicted enjoyment signal, a second set of training data; and updating one or more parameters of a personalized ranking model based on the second set of training data.

Other embodiments include, without limitation, a computer system that performs one or more aspects of the disclosed techniques, as well as one or more non-transitory computer-readable storage media including instructions for performing one or more aspects of the disclosed techniques.

The disclosed techniques achieve various advantages over prior-art techniques. In particular, personalized prediction models trained using disclosed techniques are able to more accurately predict user enjoyment of digital content items, even where the user has not provided explicit feedback. By enriching training data with predicted user enjoyment, disclosed techniques enable generation of trained personalized ranking models that can more accurately generate personalized digital content recommendations that reflect changes in user preferences over time. Further, by reducing bias in training data, disclosed techniques enable generation of trained personalized ranking models that are able to generate improved recommendations across a diverse range of users, resulting in improved user engagement and retention.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a schematic diagram illustrating a computing system configured to implement one or more aspects of the present disclosure.

FIG. 2 is a more detailed illustration of the training engine and inference engine of FIG. 1, according to various embodiments of the present disclosure.

FIG. 3 is a flowchart of method steps for personalized prediction training procedure performed by the training engine and inference engine of FIG. 1, according to various embodiments of the present disclosure.

FIG. 4 is a flowchart of method steps for a personalized ranking training procedure, according to various embodiments of the present disclosure.

FIG. 5 illustrates a network infrastructure used to distribute content to content servers and endpoint devices, according to various embodiments of the present disclosure.

FIG. 6 is a block diagram of a content server that may be implemented in conjunction with the network infrastructure of FIG. 5, according to various embodiments of the present disclosure.

FIG. 7 is a block diagram of a control server that may be implemented in conjunction with the network infrastructure of FIG. 5, according to various embodiments of the present disclosure.

FIG. 8 is a block diagram of an endpoint device that may be implemented in conjunction with the network infrastructure of FIG. 5, according to various embodiments of the present disclosure.

For clarity, identical reference numbers have been used, where applicable, to designate identical elements that are common between figures. It is contemplated that features of one embodiment may be incorporated in other embodiments without further recitation.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

The increased need to personalize content to suit the individual tastes and preferences of the users has resulted in the use of ranking algorithms to determine which digital content items in a media library to present to a user interface of an endpoint device. However, the vast majority of users consume digital content items, but do not provide feedback after watching the content items. Since most ranking algorithms are trained based on this user feedback data, the ranking algorithms tend to provide rankings that are skewed towards reflecting the preferences of users who are overrepresented in the user feedback data. Further, ranking algorithms are more likely to be trained on types of digital content items that tend to receive user feedback, which may not be representative of all types of digital content items. As a result, the ranking algorithms are more likely to provide homogenized recommendations that reflect certain types of digital content items and, thus, may not have the desired effect of increased user engagement.

In addition, because most users to view items without providing feedback, ranking algorithms are often unsuccessful in creating accurate personalized predictions suited to the preferences of such users, especially for users who view a broad range of digital content items that may be different from the types of digital content that the ranking algorithms encountered during training. This problem is exacerbated by ranking algorithms typically not having any means for determining changes or variations in user preferences over time, which makes it more difficult to generate personalized predictions that increase user engagement.

In contrast, personalized prediction models trained using the disclosed techniques are better able to gauge whether users enjoyed watching digital content items where no explicit feedback is provided. During training, a training engine trains a bias-reduction pre-processing module based on a pre-processing set of training data. The training engine generates a first set of training data for the personalized prediction model. Training engine uses bias reduction pre-processing module to perform bias-reduction pre-processing on the first set of training data based on an inverse propensity (IPS) weight. Training engine generates, using the personalized prediction model, predicted enjoyment signal(s) associated with playback of one or more digital content items. Training engine determines a loss function based on the difference between the predicted enjoyment signal(s) and user feedback data associated with playback of the one or more digital content items. Training engine updates one or more parameters of the personalized prediction model based on the loss function. Training engine determines whether a threshold condition for the loss function has been achieved. When the threshold condition is achieved, training engine applies, using the weight transform module, a transform function to the predicted enjoyment signal(s) to control the range, spread, strength, or the like of the predicted enjoyment signal(s). Training engine generates a second set of training data by combining the transformed predicted enjoyment signal(s) with existing ranking weight(s). Training engine trains a personalized ranking model based on the second set of training data.

During inference, inference engine optionally obtains the trained personalized prediction model and the trained personalized ranking model. Inference engine generates, using the trained personalized ranking model, one or more predicted content recommendation(s) based on the trained personalized prediction model.

Advantageously, by enriching training data with predicted user enjoyment, the disclosed techniques enable generation of trained personalized ranking models that can more accurately generate personalized digital content recommendations that reflect changes in user preferences over time. In particular, personalized prediction models trained using the disclosed techniques are able to more accurately predict user enjoyment of digital content items, even where the user has not provided explicit feedback. Further, by reducing bias in training data, disclosed techniques enable generation of trained personalized ranking models that are able to generate improved recommendations across a diverse range of users, resulting in improved user engagement and retention.

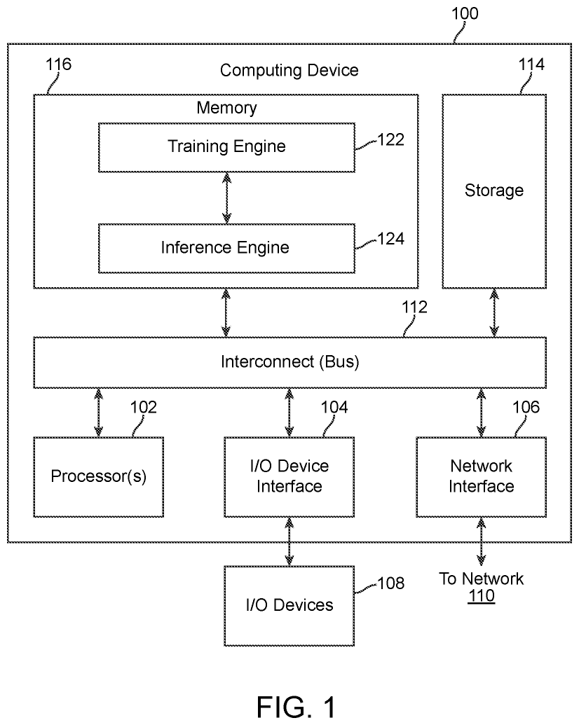

FIG. 1 illustrates a computing device 100 configured to implement one or more aspects of the present disclosure. As shown, computing device 100 includes an interconnect (bus) 112 that connects one or more processor(s) 102, an input/output (I/O) device interface 104 coupled to one or more input/output (I/O) devices 108, memory 116, a storage 114, and a network interface 106.

Computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 described herein is illustrative and that any other technically feasible configurations fall within the scope of the present disclosure.

Processor(s) 102 includes any suitable processor implemented as a central processing unit (CPU), a graphics processing unit (GPU), an application-specific integrated circuit (ASIC), a field programmable gate array (FPGA), an artificial intelligence (AI) accelerator, any other type of processor, or a combination of different processors, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O device interface 104 enables communication of I/O devices 108 with processor(s) 102. I/O device interface 104 generally includes the requisite logic for interpreting addresses corresponding to I/O devices 108 that are generated by processor(s) 102. I/O device interface 104 may also be configured to implement handshaking between processor(s) 102 and I/O devices 108, and/or generate interrupts associated with I/O devices 108. I/O device interface 104 may be implemented as any technically feasible CPU, ASIC, FPGA, any other type of processing unit or device.

In one embodiment, I/O devices 108 include devices capable of providing input, such as a keyboard, a mouse, a touch-sensitive screen, and so forth, as well as devices capable of providing output, such as a display device. Additionally, I/O devices 108 may include devices capable of both receiving input and providing output, such as a touchscreen, a universal serial bus (USB) port, and so forth. I/O devices 108 may be configured to receive various types of input from an end-user of computing device 100, and to also provide various types of output to the end-user of computing device 100, such as displayed digital images or digital videos or text. In some embodiments, one or more of I/O devices 108 are configured to couple computing device 100 to a network 110.

Network 110 includes any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

Interconnect (bus) 112 includes one or more reconfigurable interconnects that links one or more components of computing device 100 such as one or more processors, one or more input/output ports, storage, memory, or the like. In some embodiments, interconnect (bus) 112 combines the functions of a data bus, an address bus, a control bus, or the like. In some embodiments, interconnect (bus) 112 includes an I/O bus, a single system bus, a shared system bus, a local bus, a peripheral bus, an external bus, a dual independent bus, or the like.

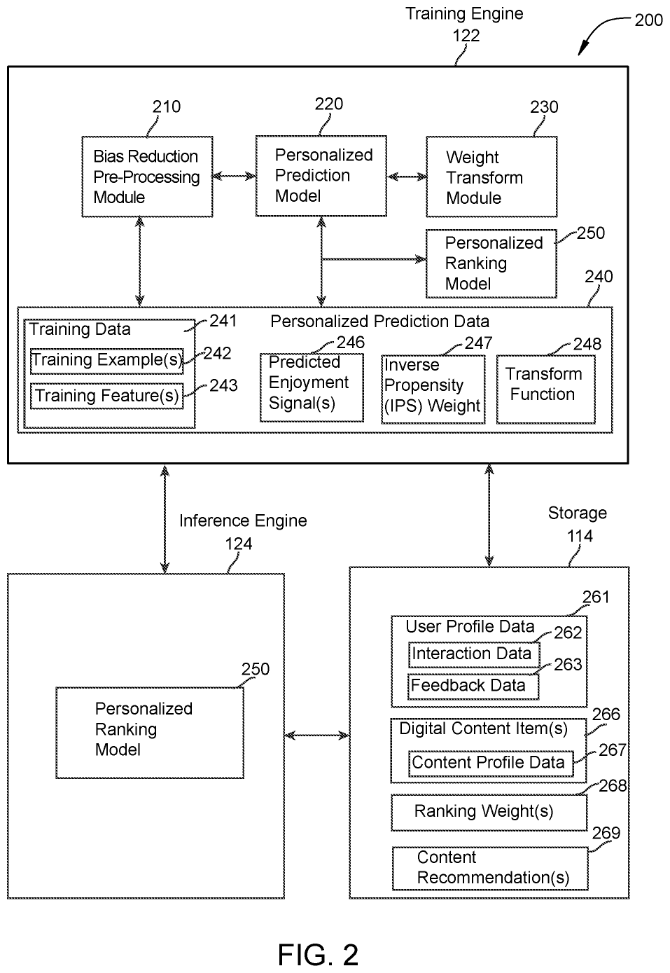

Memory 116 includes a random access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including training engine 122 and inference engine 124. Training engine 122 and inference engine 124 are described in further detail below with respect to FIG. 2.

Storage 114 includes non-volatile storage for applications and data, and may include fixed or removable disk drives, flash memory devices, and CD-ROM, DVD-ROM, Blu-Ray, HD-DVD, or other magnetic, optical, or solid state storage devices. Training engine 122 and inference engine 124 may be stored in storage 114 and loaded into memory 116 when executed.

FIG. 2 is a more detailed illustration of training engine 122 and inference engine 124 of FIG. 1, according to various embodiments of the present disclosure. As shown, training engine 122 includes, without limitation, bias reduction pre-processing module 210, personalized prediction model 220, weight transform module 230, personalized prediction data 240, and/or personalized ranking model 250.

Personalized prediction data 240 includes any data associated with any component of training engine 122 or the like. Personalized prediction data 240 includes, without limitation, training data 241, predicted enjoyment signal(s) 246, inverse propensity(IPS) weight 247, and/or transform function 248.

Training data 241 includes any data used to train personalized prediction model 220, personalized ranking model 250, or the like. Training data 241 includes, without limitation, training example(s) 242 and/or training feature(s) 243. Training example(s) 242 include one or more examples generated based on interaction data 262 (e.g., all video plays in a user's viewing history), feedback data 263, or the like. In some embodiments, training example(s) 242 include one or more examples selected using a sampling strategy or the like. In some embodiments, the sampling strategy includes choosing only examples with feedback data 263, choosing a random set of users where the interaction is associated with feedback (e.g., thumbs up, thumbs down), or the like.

Training feature(s) 243 include one or more features derived from the one or more training example(s) 242 or the like. In some embodiments, training feature(s) 243 include one or more types of features associated with user profile data 261, digital content item(s) 266, or the like. In some embodiments, training feature(s) 243 include user-only features (e.g., user's historical feedback frequency, user's historical number of positive feedback versus negative feedback), show-only features (e.g., total positive feedback versus negative feedback for a given digital content item 266, average watch minutes of the digital content item 266), user-show cross features (e.g., user's watch minutes for a given digital content item 266), label features (e.g., whether the user has provided feedback on the digital content item 266), or the like. In some embodiments, training feature(s) 243 include number of minutes a user has played a digital content item 266, number of fractional episodes the user has played the digital content item 266, whether the digital content item 266 is in a user's playlist, average feedback ratio of the digital content item 266, user's historical feedback ratio, fraction of the season of the digital content item 266 completed by the user, fraction of the total runtime of the digital content item 266 completed by the user, ratio between user's watched minutes and the average watched minutes of the digital content item 266, or the like. In some embodiments, training feature(s) 243 include traditional recommendation feedback prediction(s) (e.g., content recommendation(s) 269) or the like.

Predicted enjoyment signal(s) 246 comprises a prediction of a weight, score, probability value, or the like indicative of feedback (e.g., thumbs up, thumbs down), quality of engagement (e.g., positive engagement), or the like associated with a digital content item 266. In some embodiments, predicted enjoyment signal(s) 246 includes the probability of receiving a given user feedback (e.g., thumbs up, thumbs down), given that the user interacts with a digital content item (e.g., watches the digital content item) and provides feedback. In some embodiments, predicted enjoyment signal 246 indicates the probability that a user associated with an interaction (e.g., the playback a digital content item) enjoyed the digital content item, even though feedback (e.g., thumbs up, thumbs down) was not received before, during, or after the interaction. In some embodiments, predicted enjoyment signal(s) 246 includes the probability of receiving a given user feedback (e.g., thumbs up, thumbs down) based on aggregate behavioral data obtained from interaction data 262 associated with users with non-personally identifiable characteristics similar to a given user (e.g., age, demographic information, content viewing history, or the like). In some embodiments, predicted enjoyment signal(s) 246 includes the probability of receiving a given user feedback (e.g., thumbs up, thumbs down) based on real-time or historical behavior of one or more users before, during, or after interaction with one or more digital content item(s) 266. In some embodiments, predicted enjoyment signal 246 includes a prediction associated with one or more training features 243, one or more ranking weight(s) 268, or the like. In some embodiments, predicted enjoyment signal 246 is determined based on user profile data 261 (e.g., interaction data 262 indicative of how the user interacted with the digital content item 266), content profile data 267, ranking weights 268, or the like.

Inverse propensity (IPS) weight 247 comprises any weight, score, probability value, or the like applied to training data 241 to address any bias associated with users with a certain feedback tendency (e.g., users who tend to provide most of the feedback on digital content items) or the like. In some embodiments, IPS weight 247 includes a weight applied to address distribution differences between training and inference or the like (e.g., different frequencies of providing feedback across the set of users represented in the training data versus during inference). In some embodiments, IPS weight 247 includes a weight associated with the probability of a user providing feedback (e.g., thumbs up, thumbs down) before, during, or after the interaction with a digital content item 266. In some embodiments, IPS weight 247 comprises the reciprocal of the probability that the user provides feedback. In some embodiments, the probability is based on one or more statistical properties (e.g., mean values, minimum or maximum values, standard deviation, range of values, median values, or the like) associated with user profile data 261 (e.g., user's past behavior), content profile data 267, or the like. In some embodiments, IPS weight 247 is obtained using a model trained to predict whether or not a user provides feedback on a given digital content item 266.

Transform function 248 includes a function, weight, score, probability value, or the like configured to fine-tune the range, spread, strength, or the like of the predicted enjoyment signal(s) 246. In some embodiments, transform function 248 includes a weight obtained using a model trained to predict the optimal range, spread, strength, or the like of the predicted enjoyment signal(s) 246. In some embodiments, transform function 248 is associated with a monotonic function configured to control the range, spread, strength, or the like of the predicted enjoyment signal(s) 246. In some embodiments, the monotonic function is based on the following equation:

f(p)=1/(1-min(0.98,p)) (1)

In the above equation, p represents the predicted enjoyment signal 246. In some embodiments, p represents the probability of a positive feedback (e.g., thumbs up), given that the user interacts with a digital content item (e.g., watches the digital content item) and provides feedback. In some embodiments, the monotonic function is based on the following equation:

f(p)=p^{x} (2)

In the above equation, x is a range of weights set to a predetermined degree such as 1, 2, 3, or the like.

Storage 114 includes, without limitation, user profile data 261, digital content item(s) 266, ranking weight(s) 268, and/or content recommendation(s) 269. User profile data 261 includes any data associated with one or more users. In some embodiments, user profile data 261 includes user watch pattern(s), viewing history, feedback history, or the like. User profile data 261 includes, without limitation, interaction data 262, and/or feedback data 263. Interaction data 262 includes any data associated with one or more user interactions with one or more digital content item(s) 266. In some embodiments, interaction data 262 includes duration of play (e.g., number of minutes played), number of episodes played, addition or removal of a digital content item 266 from a user's playlist, user watch patterns (e.g., types of digital content item preferred by the user), viewing history (e.g., whether a user watches more of the current digital content item or moves on to another digital content item, user interaction with digital content items watched before or after the current digital content item, changes in types of digital content items watched over time, abandoned plays), user's typical behavioral patterns (e.g., user's average watch minutes, user feedback tendency), or the like. In some embodiments, interaction data 262 is obtained based on data obtained from one or more sensors included in one or more I/O devices 108 or the like.

Feedback data 263 includes any data associated with feedback provided by one or more users before, during, or after interaction with one or more digital content item(s) 266. In some embodiments, feedback data 263 include one or more ratings, comments, or the like indicative of the degree of user enjoyment, engagement, or the like with a digital content item 266. In some embodiments, feedback data 263 includes user input using a toggle button, sliding scale, dial, text box or the like. In some embodiments, feedback data 263 includes one or more statistical properties (e.g., mean values, minimum or maximum values, standard deviation, range of values, median values, and/or the like) associated with feedback provided by one or more users. In some embodiments, feedback data 263 includes one or more values associated with feedback frequency (e.g., the feedback count relative to the number of digital content items 266 viewed or the like). In some embodiments, feedback data 263 includes explicit feedback prediction(s) from one or more traditional recommendation algorithms or the like. In some embodiments, feedback data 263 is based on aggregate training data obtained from interaction data 262 In some embodiments, feedback data 263 includes real-time or dynamically generated data on trends or predictions associated with real-time or historical behavior of one or more users before, during, or after interaction with one or more digital content item(s) 266. In some embodiments, feedback data 263 is obtained based on data obtained from one or more sensors included in one or more I/O devices 108 or the like.

Digital content item(s) 266 includes any media content (e.g., movies, video games, music, podcasts, news, sports, ringtones, advertisements, broadcasts, audiobooks, or the like) that can be transmitted over any technically feasible network. Digital content item(s) 266 includes one or more frames of content in any combination of resolutions such as 4 k (e.g., 4096×2160 pixels), 8 k (e.g., 7680×4320 pixels), quad HD (e.g., 3840×2160 pixels), full HD (e.g., 1920×1080 pixels), HD (e.g., 1280×720 pixels), SD (e.g., 720×480 pixels), 2 k (e.g., 2048×1080 pixels), or the like. In some embodiments, digital content item(s) 266 includes one or more frames of compressed or encoded content encoded in any combination of multimedia compression formats (e.g., Motion Pictures Expert Group (MPEG)-5, Versatile Video Coding (VVC), MPEG-H, H.265, Advanced Video Coding (AVC), MJPEG, or the like). In some embodiments, digital content item(s) 266 includes one or more frames of compressed content, where the data is compressed using any combination of intra-frame compression, interframe compression, or the like. In some embodiments, digital content item(s) 266 includes one or more frames of content compressed using any technically feasible compression technique such as discrete cosine transform (DCT), motion compensation (MC), or the like. Digital content item(s) 266 include, without limitation, content profile data 267.

Content profile data 267 includes any data associated with one or more digital content item(s) 266. In some embodiments, content profile data includes one or more statistical properties (e.g., mean values, minimum or maximum values, standard deviation, range of values, median values, or the like) associated with one or more characteristics of a given digital content item 266 (e.g., video quality, resolution, compression format, duration, content category, positive feedback versus negative feedback, watch minutes across a range of users, days since release, genre, title-level metadata, frame-level metadata, scene-level metadata, or the like). In some embodiments, content profile data 267 includes data associated with one or more metrics associated with the popularity of a given digital content item 266 such as aggregate user feedback (e.g., average user ratings), aggregate critics' feedback (e.g., average critics' rating), box office performance, or the like.

Ranking weight(s) 268 include a weight, score, probability value, or the like associated with the likelihood of recommending a given digital content item 266 to a given user. In some embodiments, ranking weight(s) 268 are determined based on one or more statistical properties (e.g., mean values, minimum or maximum values, standard deviation, range of values, median values, or the like) associated with user profile data 261, content profile data 267, or the like. In some embodiments, ranking weight(s) 268 is associated with average duration of play of a digital content item 266, prediction of the remaining time that a user will watch a digital content item 266 based on time already watched, or the like.

Content recommendation(s) 269 include one or more digital content item(s) 266 selected for display to a given user. In some embodiments, content recommendation(s) 269 include a sequence of one or more digital content item(s) 266 displayed to a user for a predefined window of time, one or more choices regarding placement of the one or more digital content item(s) 266 on a page displayed to a given user, one or more rankings for a given digital content item 266 displayed to the user, or the like.

Bias reduction pre-processing module 210 includes any technically feasible machine learning model. In some embodiments, bias reduction pre-processing module 210 includes regression models, time series models, support vector machines, decision trees, random forests, XGBoost, AdaBoost, CatBoost, LightGBM, gradient boosted decision trees, naïve Bayes classifiers, Bayesian networks, hierarchical models, ensemble models, autoregressive moving average (ARMA) models, autoregressive integrated moving average (ARIMA) models, or the like. In some embodiments, bias reduction pre-processing module 210 includes recurrent neural networks (RNNs), convolutional neural networks (CNNs), deep neural networks (DNNs), deep convolutional networks (DCNs), deep belief networks (DBNs), restricted Boltzmann machines (RBMs), long-short-term memory (LSTM) units, gated recurrent units (GRUs), generative adversarial networks (LANs), self-organizing maps (SOMs), Transformers, BERT-based (Bidirectional Encoder Representations from Transformers) models, and/or other types of artificial neural networks or components of artificial neural networks. In other embodiments, bias reduction pre-processing module 210 includes functionality to perform clustering, principal component analysis (PCA), latent semantic analysis (LSA), Word2vec, or the like. In some embodiments, bias reduction pre-processing module 210 includes functionality to perform supervised learning, unsupervised learning, semi-supervised learning (e.g., supervised pre-training followed by unsupervised fine-tuning, unsupervised pre-training followed by supervised fine-tuning, or the like), self-supervised learning, or the like.

In some embodiments, bias reduction pre-processing module 210 comprises any technically feasible model trained to generate an IPS weight 247 applied to training data 241 to address any bias associated with users with a certain feedback tendency (e.g., users who tend to provide most of the feedback on digital content items) or the like. In some embodiments, bias reduction pre-processing module 210 comprises a model trained to generate an IPS weight 247 associated with the probability of a user providing feedback, a weight associated with the reciprocal of the probability that the user provides feedback, or the like. In some embodiments, bias reduction pre-processing module 210 comprises a model trained to generate an IPS weight 247 based on distribution differences (e.g., the set of users represented in the training data or the like) between training and inference or the like. In some embodiments, bias reduction pre-processing module 210 comprises a model trained to generate an IPS weight 247 based on one or more statistical properties (e.g., mean values, minimum or maximum values, standard deviation, range of values, median values, or the like) associated with user profile data 261 (e.g., user's past behavior), content profile data 267, or the like. In some embodiments, the model is trained to generate an IPS weight 247 based on statistical analysis, data mining, clustering techniques, or the like.

Personalized prediction model 220 includes any technically feasible machine learning model. In some embodiments, personalized prediction model 220 includes regression models, time series models, support vector machines, decision trees, random forests, XGBoost, AdaBoost, CatBoost, LightGBM, gradient boosted decision trees, naïve Bayes classifiers, Bayesian networks, hierarchical models, ensemble models, autoregressive moving average (ARMA) models, autoregressive integrated moving average (ARIMA) models, or the like. In some embodiments, personalized prediction model 220 includes recurrent neural networks (RNNs), convolutional neural networks (CNNs), deep neural networks (DNNs), deep convolutional networks (DCNs), deep belief networks (DBNs), restricted Boltzmann machines (RBMs), long-short-term memory (LSTM) units, gated recurrent units (GRUs), generative adversarial networks (GANs), self-organizing maps (SOMs), Transformers, BERT-based (Bidirectional Encoder Representations from Transformers) models, and/or other types of artificial neural networks or components of artificial neural networks. In other embodiments, personalized prediction model 220 includes functionality to perform clustering, principal component analysis (PCA), latent semantic analysis (LSA), Word2vec, or the like. In some embodiments, personalized prediction model 220 includes functionality to perform supervised learning, unsupervised learning, semi-supervised learning (e.g., supervised pre-training followed by unsupervised fine-tuning, unsupervised pre-training followed by supervised fine-tuning, or the like), self-supervised learning, or the like.

In some embodiments, personalized prediction model 220 comprises any technically feasible model trained to determine predicted enjoyment signal(s) 246 indicative of feedback (e.g., thumbs up, thumbs down), quality of engagement (e.g., positive engagement), or the like associated with one or more digital content items 266. In some embodiments, personalized prediction model 220 is configured to optimize a loss function, a logistic regression objective, or the like associated with feedback, quality of engagement, or the like. In some embodiments, personalized prediction model 220 determines predicted enjoyment signal(s) 246 on a real-time basis based on real-time information associated with user profile data 261, digital content item(s) 266, or the like. In some embodiments, personalized prediction model 220 determines predicted enjoyment signal(s) 246 based on dynamically generated periodic updates to user profile data 261, digital content item(s) 266, or the like. In some embodiments, personalized prediction model 220 comprises a model trained to compute predicted enjoyment signal(s) 246 based on aggregate behavioral data obtained from interaction data 262 associated with users with non-personally identifiable characteristics similar to a given user (e.g., age, location, demographic information, content viewing history, or the like). In some embodiments, personalized prediction model 220 comprises a model trained to compute predicted enjoyment signal(s) 246 based on one or more statistical properties (e.g., mean values, minimum or maximum values, standard deviation, range of values, median values, or the like) associated with user profile data 261 (e.g., interaction data 262 indicative of how the user interacted with the digital content item 266), content profile data 267, ranking weights 268, or the like. In some embodiments, the model is trained to generate a predicted enjoyment signal(s) 246 based on statistical analysis, data mining, clustering techniques, or the like.

Weight transform module 230 includes any technically feasible machine learning model. In some embodiments, weight transform module 230 includes regression models, time series models, support vector machines, decision trees, random forests, XGBoost, AdaBoost, CatBoost, LightGBM, gradient boosted decision trees, naïve Bayes classifiers, Bayesian networks, hierarchical models, ensemble models, autoregressive moving average (ARMA) models, autoregressive integrated moving average (ARIMA) models, or the like. In some embodiments, weight transform module 230 includes recurrent neural networks (RNNs), convolutional neural networks (CNNs), deep neural networks (DNNs), deep convolutional networks (DCNs), deep belief networks (DBNs), restricted Boltzmann machines (RBMs), long-short-term memory (LSTM) units, gated recurrent units (GRUs), generative adversarial networks (LANs), self-organizing maps (SOMs), Transformers, BERT-based (Bidirectional Encoder Representations from Transformers) models, and/or other types of artificial neural networks or components of artificial neural networks. In other embodiments, weight transform module 230 includes functionality to perform clustering, principal component analysis (PCA), latent semantic analysis (LSA), Word2vec, or the like. In some embodiments, weight transform module 230 includes functionality to perform supervised learning, unsupervised learning, semi-supervised learning (e.g., supervised pre-training followed by unsupervised fine-tuning, unsupervised pre-training followed by supervised fine-tuning, or the like), self-supervised learning, or the like.

In some embodiments, weight transform module 230 includes any model trained to determine a transform function 248 to be applied to fine-tune the range, spread, strength, or the like of the predicted enjoyment signal(s) 246. In some embodiments, weight transform module 230 includes any model trained to determine an optimal monotonic function to be applied to optimize the range, spread, strength, or the like of the predicted enjoyment signal(s) 246. In some embodiments, weight transform module 230 includes any model trained to determine a transform function 248 based on one or more statistical properties (e.g., mean values, minimum or maximum values, standard deviation, range of values, median values, or the like) associated with user profile data 261 (e.g., interaction data 262 indicative of how the user interacted with the digital content item 266), content profile data 267, ranking weights 268, or the like. In some embodiments, the model is trained to generate a transform function 248 based on statistical analysis, data mining, clustering techniques, or the like.

Personalized ranking model 250 includes any technically feasible machine learning model. In some embodiments, personalized ranking model 250 includes regression models, time series models, support vector machines, decision trees, random forests, XGBoost, AdaBoost, CatBoost, LightGBM, gradient boosted decision trees, naïve Bayes classifiers, Bayesian networks, hierarchical models, ensemble models, autoregressive moving average (ARMA) models, autoregressive integrated moving average (ARIMA) models, or the like. In some embodiments, personalized ranking model 250 includes recurrent neural networks (RNNs), convolutional neural networks (CNNs), deep neural networks (DNNs), deep convolutional networks (DCNs), deep belief networks (DBNs), restricted Boltzmann machines (RBMs), long-short-term memory (LSTM) units, gated recurrent units (GRUs), generative adversarial networks (LANs), self-organizing maps (SOMs), Transformers, BERT-based (Bidirectional Encoder Representations from Transformers) models, and/or other types of artificial neural networks or components of artificial neural networks. In other embodiments, personalized ranking model 250 includes functionality to perform clustering, principal component analysis (PCA), latent semantic analysis (LSA), Word2vec, or the like. In some embodiments, personalized ranking model 250 includes functionality to perform supervised learning, unsupervised learning, semi-supervised learning (e.g., supervised pre-training followed by unsupervised fine-tuning, unsupervised pre-training followed by supervised fine-tuning, or the like), self-supervised learning, or the like.

In some embodiments, personalized ranking model 250 includes any model trained to generate content recommendations 269 for one or more users. In some embodiments, personalized ranking model 250 generates content recommendations 269 based on ranking weight(s) 268, predicted enjoyment signal(s) 246, or the like. In some embodiments, personalized ranking model 250 is any model trained to generate content recommendations 269 based on one or more statistical properties (e.g., mean values, minimum or maximum values, standard deviation, range of values, median values, or the like) associated with user profile data 261 (e.g., interaction data 262 indicative of how the user interacted with the digital content item 266), content profile data 267, ranking weights 268, predicted enjoyment signal(s) 246, or the like. In some embodiments, the model is trained to generate content recommendations 269 based on statistical analysis, data mining, clustering techniques, or the like.

In operation, during training, a training engine trains a bias-reduction pre-processing module based on a pre-processing set of training data. Training engine 122 generates a first set of training data 241 for personalized prediction model 220. Training engine 122 uses bias reduction pre-processing module 210 to perform bias-reduction pre-processing on the first set of training data based on an inverse propensity (IPS) weight 247. Training engine 122 generates, using personalized prediction model 220, predicted enjoyment signal(s) 246 associated with playback of one or more digital content items 266. Training engine 122 determines a loss function based on the difference between the predicted enjoyment signal(s) 246 and user feedback data 263 associated with playback of the one or more digital content items 266. Training engine 122 updates one or more parameters of personalized prediction model 220 based on the loss function. Training engine 122 determines whether a threshold condition for the loss function has been achieved. When the threshold condition has been achieved, training engine 122 uses weight transform module 230 to apply a transform function 248 to the predicted enjoyment signal(s) 246. Training engine 122 generates a second set of training data 241 by combining the transformed predicted enjoyment signal(s) 246 with existing ranking weight(s) 268. Training engine 122 trains personalized ranking model 250 based on the second set of training data 241.

In another operation, during inference, inference engine 124 optionally obtains the trained personalized prediction model 220 and the trained personalized ranking model 250. Inference engine 124 generates, using trained personalized ranking model 250, one or more predicted content recommendation(s) 269 based on the trained personalized prediction model 220.

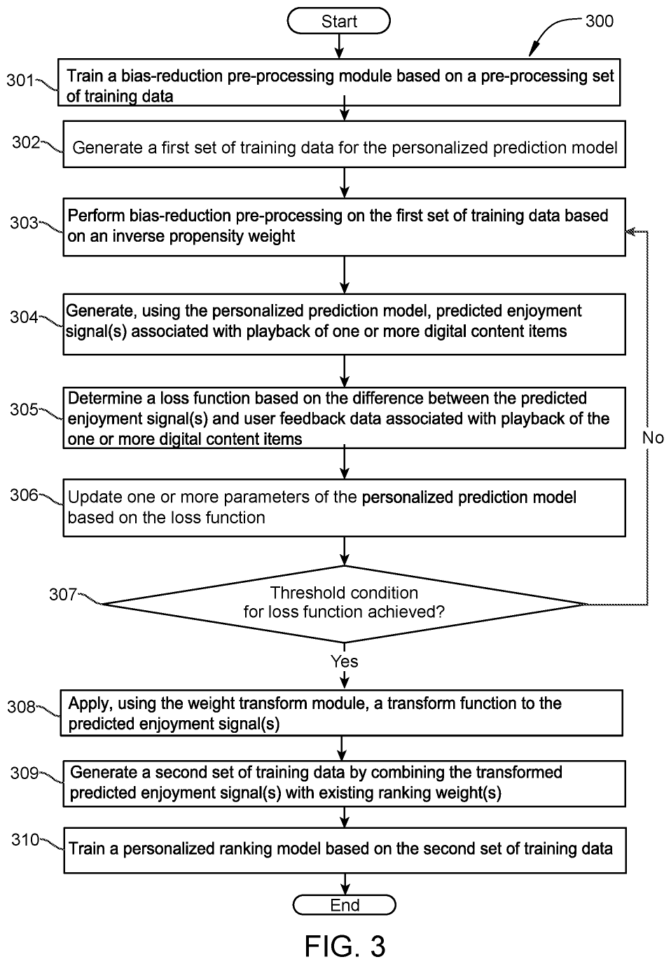

FIG. 3 is a flowchart of method steps for personalized prediction training procedure performed by the training engine and inference engine of FIG. 1, according to various embodiments of the present disclosure. Although the method steps are described in conjunction with the systems of FIGS. 1 and 2, persons skilled in the art will understand that any system configured to perform the method steps in any order falls within the scope of the present disclosure.

In step 301, training engine 122 trains bias-reduction pre-processing module 210 based on a pre-processing set of training data 241. In some embodiments, training engine 122 trains bias-reduction pre-processing module 210 using one or more hyperparameters. In some embodiments, training engine 122 updates the parameters of bias-reduction pre-processing module 210 based on a loss function. In some embodiments, training engine 122 updates the model parameters of bias-reduction pre-processing module 210 at each training iteration to reduce the value of mean square error, mean absolute error, smooth mean absolute error, log-cosh loss, quantile loss, or the like for the loss function. In some embodiments, the update is performed by propagating the loss backwards through bias-reduction pre-processing module 210 to adjust parameters of the model or weights on connections between neurons of the neural network.

In step 302, training engine 122 generates a first set of training data 241 for the personalized prediction model 220. The first set of training data 241 includes training example(s) 242 and one or more training feature(s) 243 derived from the training example(s) 242. In some embodiments, training example(s) 242 are generated based on interaction data 262, feedback data 263, or the like. In some embodiments, training feature(s) 243 include one or more types of features associated with user profile data 261, digital content item(s) 266, or the like. In some embodiments, training feature(s) 243 include user-only features, show-only features, user-show cross features, label features, or the like. In some embodiments, training feature(s) 243 include number of minutes a user has played a digital content item 266, number of fractional episodes the user has played the digital content item 266, whether the digital content item 266 is in a user's playlist, average feedback ratio of the digital content item 266, user's historical feedback ratio, fraction of the season of the digital content item 266 completed by the user, fraction of the total runtime of the digital content item 266 completed by the user, ratio between user's watched minutes and the average watched minutes of the digital content item 266, average watch duration, or the like. In some embodiments, training engine 122 (re)generates the training example(s) 242 and associated training feature(s) 243 periodically (e.g., every 14 days, over a rolling window of 21 days, or the like).

In step 303, training engine 122 uses bias reduction pre-processing module 210 to perform bias-reduction pre-processing on the first set of training data 241 based on an IPS weight 247. In some embodiments, a given IPS weight 247 is generated based on the probability of a given user providing feedback before, during, or after the playback of digital content item 266. In some embodiments, bias reduction pre-processing module 210 generates the IPS weight 247 based on distribution differences between training and inference, one or more statistical properties associated with user profile data 261, one or more statistical properties associated with content profile data 267, or the like. In some embodiments, training engine 122 applies the IPS weight 247 re-weight training example(s) 242, training feature(s) 243, or the like included in the first set of training data 241 or the like. In some embodiments, bias reduction pre-processing module 210 dynamically determines an application scheme (e.g., multiplication, addition, or the like) used to apply the IPS weight 247 to the first set of training data 241.

In step 304, training engine 122 generates, using the personalized prediction model 220, predicted enjoyment signal(s) 246 associated with playback of one or more digital content items 266. In some embodiments, a given predicted enjoyment signal 246 is associated with the probability that a user who did not provide user feedback enjoyed the playback of the digital content item 266. In some embodiments, personalized prediction model 220 determines predicted enjoyment signal(s) 246 on a real-time or periodic basis based on real-time or periodically generated information associated with user profile data 261, digital content item(s) 266, or the like. In some embodiments, personalized prediction model 220 computes predicted enjoyment signal(s) 246 based on aggregate behavioral data obtained from interaction data 262 associated with users with a characteristics similar to a given user, one or more statistical properties associated with user profile data 261, one or more statistical properties associated with content profile data 267, ranking weights 268, or the like.

In step 305, training engine 122 determines a loss function based on the difference between the predicted enjoyment signal(s) 246 and user feedback data 263 associated with playback of the one or more digital content items 266. In some embodiments, training engine 122 determines the loss function based on the difference between the predicted enjoyment signal(s) 246 and feedback data 263 such as one or more ratings, comments, or the like indicative of the degree of user enjoyment, engagement, or the like with a digital content item 266. In some embodiment, training engine 122 trains personalized prediction model 220 using one or more hyperparameters. Each hyperparameter defines “higher-level” properties of personalized prediction model 220 instead of internal parameters of personalized prediction model 220 that are updated during training of personalized prediction model 220 and subsequently used to generate predictions, inferences, scores, and/or other output of personalized prediction model 220. Hyperparameters include a learning rate (e.g., a step size in gradient descent), a convergence parameter that controls the rate of convergence in a machine learning model, a model topology (e.g., the number of layers in a neural network or deep learning model), a number of training samples in training data for a machine learning model, a parameter-optimization technique (e.g., a formula and/or gradient descent technique used to update parameters of a machine learning model), a data-augmentation parameter that applies transformations to features inputted into personalized prediction model 220, a model type (e.g., neural network, clustering technique, regression model, support vector machine, tree-based model, ensemble model, etc.), or the like.

In step 306, training engine 122 updates one or more parameters of the personalized prediction model 220 based on the loss function. In some embodiments, training engine 122 updates the model parameters of personalized prediction model 220 at each training iteration to reduce the value of mean square error, mean absolute error, smooth mean absolute error, log-cosh loss, quantile loss, or the like for the loss function. In some embodiments, the update is performed by propagating the loss backwards through personalized prediction model 220 to adjust parameters of the model or weights on connections between neurons of the neural network. In some embodiments, training engine 122 computes the gradient of the loss function with respect to the parameters of the neural network comprising personalized prediction model 220, and updates the parameters by taking a step in a direction opposite to the gradient. In one instance, the magnitude of the step is determined by a training rate, which can be a constant rate (e.g., a step size of 0.001, or the like).

In step 307, training engine 122 determines whether a threshold condition for the loss function has been achieved. In some embodiments, training engine 122 repeats the training process for multiple iterations until a threshold condition is achieved. In some embodiments, the threshold condition is achieved when the training process reaches convergence. For instance, convergence is reached when the mean square error, mean absolute error, smooth mean absolute error, log-cosh loss, quantile loss, or the like associated with for the loss function stays constant after a certain number of iterations. In some embodiments, the threshold condition is a predetermined value or range for mean square error, mean absolute error, smooth mean absolute error, log-cosh loss, quantile loss, or the like associated with the loss function. In some embodiments, the threshold condition is a certain number of iterations of the training process (e.g., 50 epochs, 800 epochs), a predetermined amount of time (e.g., 8 hours, 10 hours, 40 hours), or the like.

When the threshold condition is achieved, the training engine 122 advances the personalized prediction training procedure to step 308. When the threshold condition has not been achieved, the training engine 122 repeats a portion of the personalized prediction training procedure beginning with step 303.

In step 308, training engine 122 applies, using the weight transform module 230, a transform function 248 to the predicted enjoyment signal(s) 246. In some embodiments, weight transform module 230 applies the transform function 248 to control the range, spread, strength, or the like of the predicted enjoyment signal(s) 246. In some embodiments, weight transform module 230 applies the transform function 248 to dynamically generate a flexible range between the maximum value, the minimum value, or the like of the predicted enjoyment signal(s) 246. In some embodiments, weight transform module 230 generates the transform function 248 based on one or more statistical properties associated with user profile data 261, one or more statistical properties associated with content profile data 267, ranking weights 268, or the like. In some embodiments, weight transform module 230 dynamically determines an application scheme (e.g., multiplication, addition, or the like) used to apply the transform function 248 to the predicted enjoyment signal(s) 246.

In step 309, training engine 122 generates a second set of training data 241 by combining the transformed predicted enjoyment signal(s) 246 with existing ranking weight(s) 268. In some embodiments, training engine 122 dynamically determines an application scheme (e.g., multiplication, addition, or the like) used to combine the transformed predicted enjoyment signal(s) 246 with the existing ranking weight(s) 268 to generate the second set of training data 241. In some embodiments, training engine 122 uses the transformed predicted enjoyment signal(s) 246 to augment certain training example(s) 242 (e.g., positive examples, training examples with no associated feedback data), generate new training features(s) 243, or the like.

In step 310, training engine 122 trains a personalized ranking model 250 based on the second set of training data 241. In some embodiments, training engine determines a loss function associated with personalized ranking model 250 based on the difference between content recommendations 269 and user feedback data 263 associated with playback of the one or more digital content items 266. In some embodiment, training engine 122 trains personalized ranking model 250 using one or more hyperparameters. In some embodiments, training engine 122 updates the parameters of personalized ranking model 250 based on the loss function. In some embodiments, training engine 122 updates the model parameters of personalized ranking model 250 at each training iteration to reduce the value of mean square error, mean absolute error, smooth mean absolute error, log-cosh loss, quantile loss, or the like for the loss function. In some embodiments, the update is performed by propagating the loss backwards through personalized ranking model 250 to adjust parameters of the model or weights on connections between neurons of the neural network.

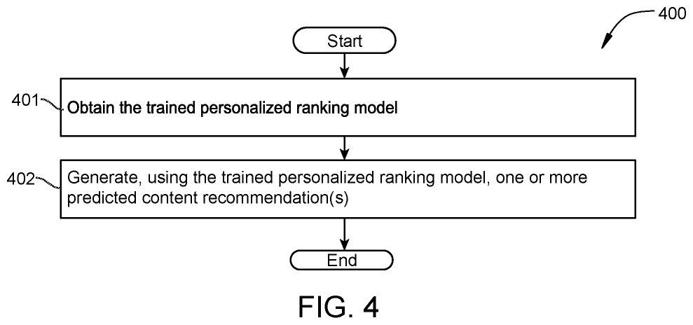

FIG. 4 is a flowchart of method steps for a personalized ranking training procedure, according to various embodiments of the present disclosure. Although the method steps are described in conjunction with the systems of FIGS. 1 and 2, persons skilled in the art will understand that any system configured to perform the method steps in any order falls within the scope of the present disclosure.

In step 401, inference engine 124 optionally obtains the trained personalized ranking model 250. In some embodiments, inference engine 124 obtains the trained personalized ranking model 250 after training engine 122 trains the model based on the second set of training data 241.

In step 402, inference engine 124 generates, using the trained personalized ranking model 250, one or more predicted content recommendation(s) 269. In some embodiments, inference engine 124 uses the transformed predicted enjoyment signal(s) 246 associated with trained personalized prediction model 220 to augment interaction data 262, feedback data 263, or the like used by personalized ranking model 250 to generate predicted content recommendations 269. In some embodiments, personalized ranking model 250 generates predicted content recommendations 269 based on a combination of ranking weight(s) 268, transformed predicted enjoyment signal(s) 246 associated with trained personalized prediction model 220, interaction data 262, feedback data 263, or the like. In some embodiments, inference engine 124 dynamically determines an application scheme (e.g., multiplication, addition, or the like) used to combine the transformed predicted enjoyment signal(s) 246 associated with trained personalized prediction model 220 with the ranking weight(s) 268, interaction data 262, feedback data 263, or the like to support the generation of predicted content recommendations 269.

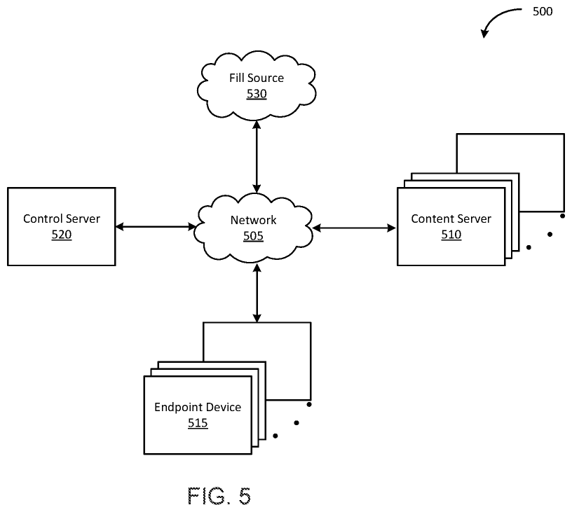

FIG. 5 illustrates a network infrastructure 500 used to distribute content to content servers 510 and endpoint devices 515, according to various embodiments of the invention. As shown, the network infrastructure 500 includes content servers 510, control server 520, and endpoint devices 515, each of which are connected via a network 505.

Each endpoint device 515 communicates with one or more content servers 510 (also referred to as “caches” or “nodes”) via the network 505 to download content, such as textual data, graphical data, audio data, video data, and other types of data. The downloadable content, also referred to herein as a “file,” is then presented to a user of one or more endpoint devices 515. In various embodiments, the endpoint devices 515 may include computer systems, set top boxes, mobile computer, smartphones, tablets, console and handheld video game systems, digital video recorders (DVRs), DVD players, connected digital TVs, dedicated media streaming devices, (e.g., the Roku® set-top box), and/or any other technically feasible computing platform that has network connectivity and is capable of presenting content, such as text, images, video, and/or audio content, to a user.

Each content server 510 may include a web-server, database, and server application 617 configured to communicate with the control server 520 to determine the location and availability of various files that are tracked and managed by the control server 520. Each content server 510 may further communicate with a fill source 530 and one or more other content servers 510 in order “fill” each content server 510 with copies of various files. In addition, content servers 510 may respond to requests for files received from endpoint devices 515. The files may then be distributed from the content server 510 or via a broader content distribution network. In some embodiments, the content servers 510 enable users to authenticate (e.g., using a username and password) in order to access files stored on the content servers 510. Although only a single control server 520 is shown in FIG. 5, in various embodiments multiple control servers 520 may be implemented to track and manage files.

In various embodiments, the fill source 530 may include an online storage service (e.g., Amazon® Simple Storage Service, Google® Cloud Storage, etc.) in which a catalog of files, including thousands or millions of files, is stored and accessed in order to fill the content servers 510. Although only a single fill source 530 is shown in FIG. 5, in various embodiments multiple fill sources 530 may be implemented to service requests for files. Further, as is well-understood, any cloud-based services can be included in the architecture of FIG. 5 beyond fill source 530 to the extent desired or necessary.

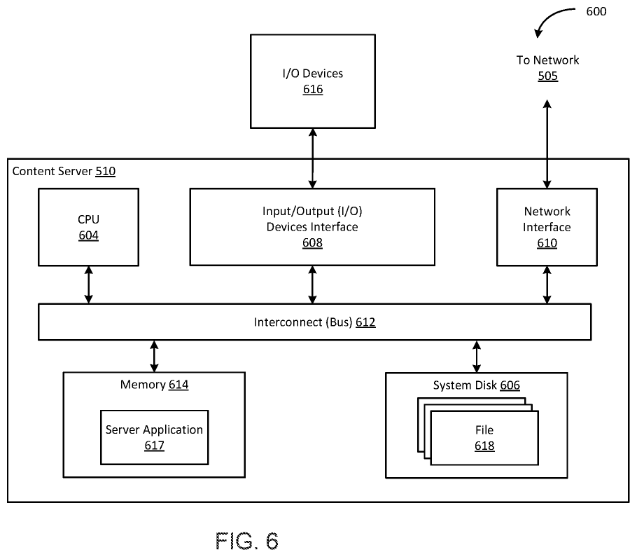

FIG. 6 is a block diagram of a content server 510 that may be implemented in conjunction with the network infrastructure 500 of FIG. 5, according to various embodiments of the present invention. As shown, the content server 510 includes, without limitation, a central processing unit (CPU) 604, a system disk 606, an input/output (I/O) devices interface 608, a network interface 610, an interconnect 612, and a system memory 614.

The CPU 604 is configured to retrieve and execute programming instructions, such as server application 617, stored in the system memory 614. Similarly, the CPU 604 is configured to store application data (e.g., software libraries) and retrieve application data from the system memory 614. The interconnect 612 is configured to facilitate transmission of data, such as programming instructions and application data, between the CPU 604, the system disk 606, I/O devices interface 608, the network interface 610, and the system memory 614. The I/O devices interface 608 is configured to receive input data from I/O devices 616 and transmit the input data to the CPU 604 via the interconnect 612. For example, I/O devices 616 may include one or more buttons, a keyboard, a mouse, and/or other input devices. The I/O devices interface 608 is further configured to receive output data from the CPU 604 via the interconnect 612 and transmit the output data to the I/O devices 616.

The system disk 606 may include one or more hard disk drives, solid state storage devices, or similar storage devices. The system disk 606 is configured to store non-volatile data such as files 618 (e.g., audio files, video files, subtitles, application files, software libraries, etc.). The files 618 can then be retrieved by one or more endpoint devices 515 via the network 505. In some embodiments, the network interface 610 is configured to operate in compliance with the Ethernet standard.

The system memory 614 includes a server application 617 configured to service requests for files 618 received from endpoint device 515 and other content servers 510. When the server application 617 receives a request for a file 618, the server application 617 retrieves the corresponding file 618 from the system disk 606 and transmits the file 618 to an endpoint device 515 or a content server 510 via the network 505.

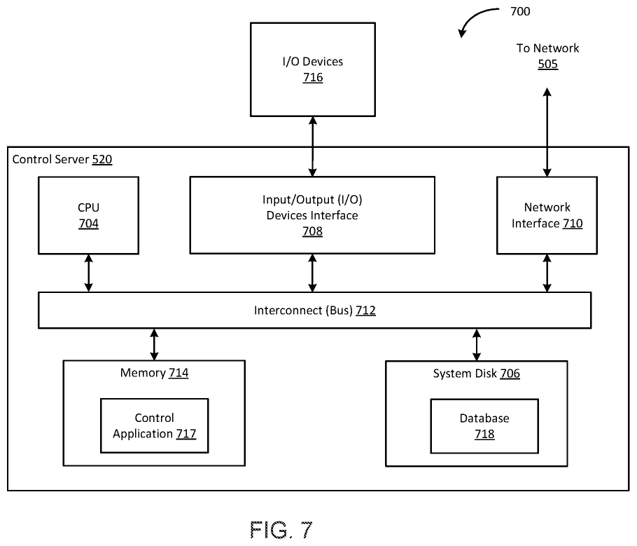

FIG. 7 is a block diagram of a control server 520 that may be implemented in conjunction with the network infrastructure 500 of FIG. 5, according to various embodiments of the present invention. As shown, the control server 520 includes, without limitation, a central processing unit (CPU) 704, a system disk 706, an input/output (I/O) devices interface 708, a network interface 710, an interconnect 712, and a system memory 714.

The CPU 704 is configured to retrieve and execute programming instructions, such as control application 717, stored in the system memory 714. Similarly, the CPU 704 is configured to store application data (e.g., software libraries) and retrieve application data from the system memory 714 and a database 718 stored in the system disk 706. The interconnect 712 is configured to facilitate transmission of data between the CPU 704, the system disk 706, I/O devices interface 708, the network interface 710, and the system memory 714. The I/O devices interface 708 is configured to transmit input data and output data between the I/O devices 716 and the CPU 704 via the interconnect 712. The system disk 706 may include one or more hard disk drives, solid state storage devices, and the like. The system disk 706 is configured to store a database 718 of information associated with the content servers 510, the fill source(s) 530, and the files 618.

The system memory 714 includes a control application 717 configured to access information stored in the database 718 and process the information to determine the manner in which specific files 618 will be replicated across content servers 510 included in the network infrastructure 500. The control application 717 may further be configured to receive and analyze performance characteristics associated with one or more of the content servers 510 and/or endpoint devices 515.

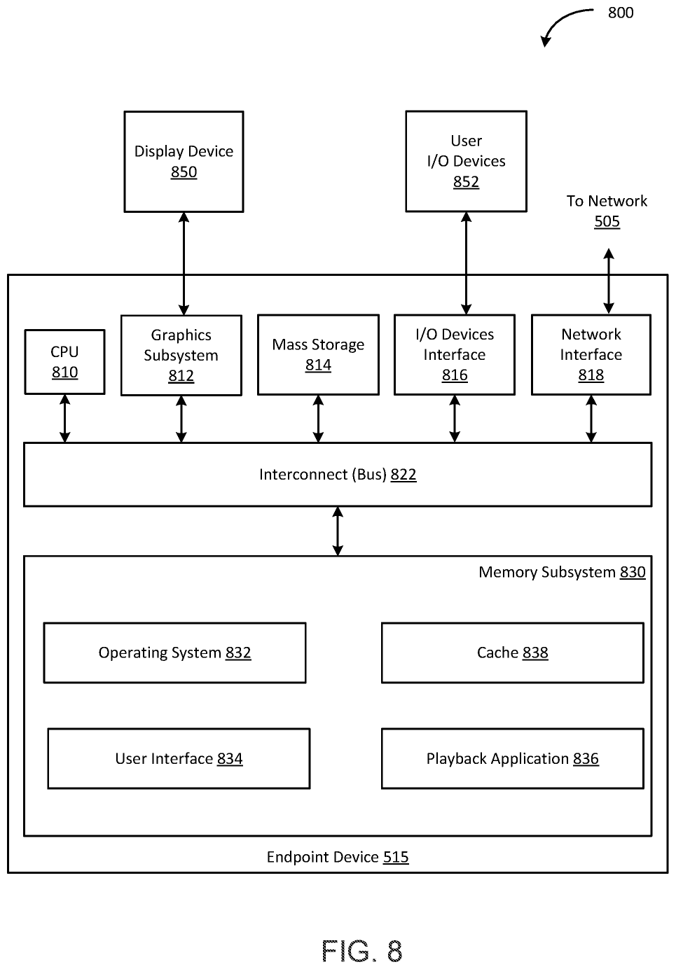

FIG. 8 is a block diagram of an endpoint device 515 that may be implemented in conjunction with the network infrastructure 500 of FIG. 5, according to various embodiments of the present invention. As shown, the endpoint device 515 may include, without limitation, a CPU 810, a graphics subsystem 812, an I/O device interface 814, a mass storage unit 816, a network interface 818, an interconnect 822, and a memory subsystem 830.

In some embodiments, the CPU 810 is configured to retrieve and execute programming instructions stored in the memory subsystem 830. Similarly, the CPU 810 is configured to store and retrieve application data (e.g., software libraries) residing in the memory subsystem 830. The interconnect 822 is configured to facilitate transmission of data, such as programming instructions and application data, between the CPU 810, graphics subsystem 812, I/O devices interface 814, mass storage unit 816, network interface 818, and memory subsystem 830.

In some embodiments, the graphics subsystem 812 is configured to generate frames of video data and transmit the frames of video data to display device 850. In some embodiments, the graphics subsystem 812 may be integrated into an integrated circuit, along with the CPU 810. The display device 850 may comprise any technically feasible means for generating an image for display. For example, the display device 850 may be fabricated using liquid crystal display (LCD) technology, cathode-ray technology, and light-emitting diode (LED) display technology. An input/output (I/O) device interface 814 is configured to receive input data from user I/O devices 852 and transmit the input data to the CPU 810 via the interconnect 822. For example, user I/O devices 852 may comprise one of more buttons, a keyboard, and a mouse or other pointing device. The I/O device interface 814 also includes an audio output unit configured to generate an electrical audio output signal. User I/O devices 852 includes a speaker configured to generate an acoustic output in response to the electrical audio output signal. In alternative embodiments, the display device 850 may include the speaker. A television is an example of a device known in the art that can display video frames and generate an acoustic output.

A mass storage unit 816, such as a hard disk drive or flash memory storage drive, is configured to store non-volatile data. A network interface 818 is configured to transmit and receive packets of data via the network 505. In some embodiments, the network interface 818 is configured to communicate using the well-known Ethernet standard. The network interface 818 is coupled to the CPU 810 via the interconnect 822.

In some embodiments, the memory subsystem 830 includes programming instructions and application data that comprise an operating system 832, a user interface 834, and a playback application 836. The operating system 832 performs system management functions such as managing hardware devices including the network interface 818, mass storage unit 816, I/O device interface 814, and graphics subsystem 812. The operating system 832 also provides process and memory management models for the user interface 834 and the playback application 836. The user interface 834, such as a window and object metaphor, provides a mechanism for user interaction with endpoint device 515. Persons skilled in the art will recognize the various operating systems and user interfaces that are well-known in the art and suitable for incorporation into the endpoint device 515.

In some embodiments, the playback application 836 is configured to request and receive content from the content server 510 via the network interface 818. Further, the playback application 836 is configured to interpret the content and present the content via display device 850 and/or user I/O devices 852.

In sum, during training, training engine 122 generates a first set of training data 241 for personalized prediction model 220. Training engine 122 uses bias reduction pre-processing module 210 to perform bias-reduction pre-processing on the first set of training data based on an inverse propensity (IPS) weight 247. Training engine 122 generates, using personalized prediction model 220, predicted enjoyment signal(s) 246 associated with playback of one or more digital content items 266. Training engine 122 determines a loss function based on the difference between the predicted enjoyment signal(s) 246 and user feedback data 263 associated with playback of the one or more digital content items 266. Training engine 122 updates one or more parameters of personalized prediction model 220 based on the loss function. Training engine 122 determines whether a threshold condition for the loss function has been achieved. When the threshold condition has been achieved, training engine 122 uses weight transform module 230 to apply a transform function 248 to the predicted enjoyment signal(s) 246. Training engine 122 generates a second set of training data 241 by combining the transformed predicted enjoyment signal(s) 246 with existing ranking weight(s) 268. Training engine 122 trains personalized ranking model 250 based on the second set of training data 241.

During inference, inference engine 124 optionally obtains the trained personalized ranking model 250. Inference engine 124 generates, using trained personalized ranking model 250, one or more predicted content recommendation(s) for a given user based on or more attributes of the user and the playback environment. Advantageously, by enriching training data with predicted user enjoyment, disclosed techniques enable generation of trained personalized ranking models that can more accurately generate personalized digital content recommendations that reflect changes in user preferences over time. In particular, personalized prediction models trained using disclosed techniques are able to more accurately predict user enjoyment of digital content items, even where the user has not provided explicit feedback. Further, by reducing bias in training data, disclosed techniques enable generation of trained personalized ranking models that are able to generate improved recommendations across a diverse range of users, resulting in improved user engagement and retention.

1. In various embodiments, a computer-implemented method comprises generating, based on interaction data associated with one or more users and a first weight associated with the interaction data, a first set of training data, generating, based on a personalized prediction model, a predicted enjoyment signal associated with playback of a digital content item, generating, based on the first set of training data and the predicted enjoyment signal, a second set of training data, and updating one or more parameters of a personalized ranking model based on the second set of training data.

2. The computer-implemented method of clause 1, further comprising updating one or more parameters of the personalized prediction model based on the first set of training data.

3. The computer-implemented method of clause 1 or 2, further comprising generating, based on a second weight, a transformed predicted enjoyment signal.

4. The computer-implemented method of any of clauses 1-3, where the second weight is associated with a monotonic function configured to optimize a range of the predicted enjoyment signal.

5. The computer-implemented method of any of clauses 1-4, where generating the second set of training data further comprises combining the transformed predicted enjoyment signal with a first ranking weight used to generate a second ranking weight.

6. The computer-implemented method of any of clauses 1-5, further comprising generating, using the personalized ranking model, one or more content recommendations based on the second ranking weight.

7. The computer-implemented method of any of clauses 1-6, where the predicted enjoyment signal is associated with a probability that a user who did not provide user feedback enjoyed the playback of the digital content item.

8. The computer-implemented method of any of clauses 1-7, where the first weight is generated based on a probability of the one or more users providing user feedback associated with the playback of the digital content item.

9. The computer-implemented method of any of clauses 1-8, further comprising determining a loss function based on the second set of training data, and determining, based on the loss function, whether a threshold condition is achieved.

10. The computer-implemented method of any of clauses 1-9, further comprising updating the one or more parameters of a personalized ranking model to reduce at least one of: mean square error, mean absolute error, smooth mean absolute error, log-cosh loss, quantile loss associated with the loss function.

11. In various embodiments, one or more non-transitory computer-readable media store instructions that, when executed by one or more processors, cause the one or more processors to perform the steps of generating, based on interaction data associated with one or more users and a first weight associated with the interaction data, a first set of training data, generating, based on a personalized prediction model, a predicted enjoyment signal associated with playback of a digital content item, generating, based on the first set of training data and the predicted enjoyment signal, a second set of training data, and updating one or more parameters of a personalized ranking model based on the second set of training data.

12. The one or more non-transitory computer-readable media of clause 11, further storing instructions that, when executed by the one or more processors, cause the one or more processors to perform the steps of updating one or more parameters of the personalized prediction model based on the first set of training data.

13. The one or more non-transitory computer-readable media of clause 11 or 12, further storing instructions that, when executed by the one or more processors, cause the one or more processors to perform the steps of generating, based on a second weight, a transformed predicted enjoyment signal.

14. The one or more non-transitory computer-readable media of any of clauses 11-13, where the second weight is associated with a monotonic function configured to optimize a range of the predicted enjoyment signal.

15. The one or more non-transitory computer-readable media of any of clauses 11-14, where generating the second set of training data further comprises combining the transformed predicted enjoyment signal with a first ranking weight used to generate a second ranking weight.

16. The one or more non-transitory computer-readable media of any of clauses 11-15, further storing instructions that, when executed by the one or more processors, cause the one or more processors to perform the steps of generating, using the personalized ranking model, one or more content recommendations based on the second ranking weight.

17. The one or more non-transitory computer-readable media of any of clauses 11-16, where the predicted enjoyment signal is associated with a probability that a user who did not provide user feedback enjoyed the playback of the digital content item.

18. The one or more non-transitory computer-readable media of any of clauses 11-17, where the first weight is generated based on a probability of the one or more users providing user feedback associated with the playback of the digital content item.

19. In various embodiments, a system comprises a memory storing one or more software applications, and a processor that, when executing the one or more software applications, is configured to perform the steps of generating, based on interaction data associated with one or more users and a first weight associated with the interaction data, a first set of training data, generating, based on a personalized prediction model, a predicted enjoyment signal associated with playback of a digital content item, generating, based on the first set of training data and the predicted enjoyment signal, a second set of training data, and updating one or more parameters of a personalized ranking model based on the second set of training data.

20. In various embodiments, a computer-implemented method comprises processing one or more attributes associated with a given user using a personalized ranking model to identify a set of content items, where the personalized ranking model is trained on a training data set that is weighted based on one or more predicted enjoyment signals associated with training data included in the training a data set, and presenting at least a subset of the set of content items to the given user.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method, the method comprising:
generating, based on interaction data associated with one or more users and a first weight associated with the interaction data, a first set of training data;
generating, based on a personalized prediction model, a predicted enjoyment signal associated with playback of a digital content item;
generating, based on the first set of training data and the predicted enjoyment signal, a second set of training data; and
updating one or more parameters of a personalized ranking model based on the second set of training data.

2. The computer-implemented method of claim 1, further comprising:
updating one or more parameters of the personalized prediction model based on the first set of training data.

3. The computer-implemented method of claim 1, further comprising:
generating, based on a second weight, a transformed predicted enjoyment signal.

4. The computer-implemented method of claim 3, wherein the second weight is associated with a monotonic function configured to optimize a range of the predicted enjoyment signal.

5. The computer-implemented method of claim 3, wherein generating the second set of training data further comprises:
combining the transformed predicted enjoyment signal with a first ranking weight used to generate a second ranking weight.

6. The computer-implemented method of claim 5, further comprising:
generating, using the personalized ranking model, one or more content recommendations based on the second ranking weight.

7. The computer-implemented method of claim 1, wherein the predicted enjoyment signal is associated with a probability that a user who did not provide user feedback enjoyed the playback of the digital content item.

8. The computer-implemented method of claim 1, wherein the first weight is generated based on a probability of the one or more users providing user feedback associated with the playback of the digital content item.

9. The computer-implemented method of claim 1, further comprising:
determining a loss function based on the second set of training data; and
determining, based on the loss function, whether a threshold condition is achieved.

10. The computer-implemented method of claim 9, further comprising:
updating the one or more parameters of a personalized ranking model to reduce at least one of: mean square error, mean absolute error, smooth mean absolute error, log-cosh loss, quantile loss associated with the loss function.

11. One or more non-transitory computer-readable media storing instructions that, when executed by one or more processors, cause the one or more processors to perform the steps of:
generating, based on interaction data associated with one or more users and a first weight associated with the interaction data, a first set of training data;
generating, based on a personalized prediction model, a predicted enjoyment signal associated with playback of a digital content item;
generating, based on the first set of training data and the predicted enjoyment signal, a second set of training data; and
updating one or more parameters of a personalized ranking model based on the second set of training data.

12. The one or more non-transitory computer-readable media of claim 11, further storing instructions that, when executed by the one or more processors, cause the one or more processors to perform the steps of:
updating one or more parameters of the personalized prediction model based on the first set of training data.

13. The one or more non-transitory computer-readable media of claim 11, further storing instructions that, when executed by the one or more processors, cause the one or more processors to perform the steps of:
generating, based on a second weight, a transformed predicted enjoyment signal.

14. The one or more non-transitory computer-readable media of claim 13, wherein the second weight is associated with a monotonic function configured to optimize a range of the predicted enjoyment signal.

15. The one or more non-transitory computer-readable media of claim 13, wherein generating the second set of training data further comprises:
combining the transformed predicted enjoyment signal with a first ranking weight used to generate a second ranking weight.

16. The one or more non-transitory computer-readable media of claim 15, further storing instructions that, when executed by the one or more processors, cause the one or more processors to perform the steps of:
generating, using the personalized ranking model, one or more content recommendations based on the second ranking weight.

17. The one or more non-transitory computer-readable media of claim 11, wherein the predicted enjoyment signal is associated with a probability that a user who did not provide user feedback enjoyed the playback of the digital content item.

18. The one or more non-transitory computer-readable media of claim 11 wherein the first weight is generated based on a probability of the one or more users providing user feedback associated with the playback of the digital content item.

19. A system, comprising:
a memory storing one or more software applications; and
a processor that, when executing the one or more software applications, is configured to perform the steps of:
generating, based on interaction data associated with one or more users and a first weight associated with the interaction data, a first set of training data;
generating, based on a personalized prediction model, a predicted enjoyment signal associated with playback of a digital content item;
generating, based on the first set of training data and the predicted enjoyment signal, a second set of training data; and
updating one or more parameters of a personalized ranking model based on the second set of training data.

20. A computer-implemented method, the method comprising:
processing one or more attributes associated with a given user using a personalized ranking model to identify a set of content items, wherein the personalized ranking model is trained on a training data set that is weighted based on one or more predicted enjoyment signals associated with training data included in the training data set; and
presenting at least a subset of the set of content items to the given user.
